(19) United States
(12) Patent Application Publication
(10) Pub. No.: US 2026/0092216 A1
(43) Pub. Date: Apr. 2, 2026

(54) BIOFUEL PRODUCTION THROUGH CATALYTIC PYROLYSIS

(71) Applicant: KING FAHD UNIVERSITY OF PETROLEUM AND MINERALS, Dhahran (SA)

(72) Inventors: Abdul Gani Abdul JAMEEL, Dhahran (SA); Nabeel Ahmad Javaid AHMAD, Dhahran (SA); Usama Ahmed Mehmood AHMED, Dhahran (SA); Aniz Chennampilly UMMER, Dhahran (SA); Mohammad Nahid SIDDIQUI, Dhahran (SA); K. M. Oajedul ISLAM, Dhaka (BD); Faisal Daghash ALBAQAMI, Dhahran (SA)

(73) Assignee: KING FAHD UNIVERSITY OF PETROLEUM AND MINERALS, Dhahran (SA)

(21) Appl. No.: 18/901,074

(22) Filed: Sep. 30, 2024

(51) Int. Cl. C10B 53/02; B01J 23/08; B01J 29/40; B01J 37/02; B01J 37/08; C10B 57/06; C10B 57/10; C10L 1/04

(52) U.S. Cl. CPC C10B 53/02; B01J 23/08; B01J 29/405; B01J 37/0201; B01J 37/0236; B01J 37/08; C10B 57/06; C10B 57/10; C10L 1/04; C10L 2290/02

(57) ABSTRACT

A method to transform spent coffee grounds (SCG) waste into bio-oil using microwave-assisted pyrolysis approach includes mixing of SCG, silicon carbide granules, and a catalyst to create a homogeneous mixture. The mass ratio of coffee grounds to catalyst ranges from 10:1 to 20:1. The method further includes microwave irradiation of formed mixture to facilitate the formation of the desired product, wherein the product comprises a first vapor, a second vapor, and a char, and condensing the first vapor to form the biofuel.

### STATEMENT REGARDING PRIOR DISCLOSURE BY THE INVENTORS

Aspects of the present disclosure are described in Islam, K. M. O. et al., “Utilization of coffee waste for biofuel production through catalytic microwave-assisted pyrolysis approach” published in Biomass Conversion and Biorefinery (2024), which is incorporated herein by reference in its entirety.

### STATEMENT OF ACKNOWLEDGEMENT

Support provided by the Interdisciplinary Research Center for Refining and Advanced Chemicals, King Fahd University of Petroleum and Minerals, Saudi Arabia, through project INRC2312 is gratefully acknowledged.

### BACKGROUND

### Technical Field

The present disclosure is directed to a method of producing a biofuel, particularly to a method of producing biofuel through a microwave-assisted pyrolysis approach.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Organic wastes, derived from living organisms, are biodegradable materials that can enhance sustainable waste management and renewable energy production. By optimizing processes like composting, anaerobic digestion, and biofuel production, these wastes can be converted into valuable products, reducing environmental impact. Sources include agricultural activities, municipal solid waste, and industrial organic waste. Food processing byproducts, such as peels, seeds, and pulp, are abundant and biodegradable. These byproducts can be effectively utilized in biofuel production through biochemical and thermochemical conversion processes, contributing to sustainable energy solutions and waste management.

The disposal of spent coffee grounds (SCG) emerging as an environmental concern due to its high organic content and the potential release of greenhouse gases during decomposition; however, SCG can also serve as a valuable resource owing to its high content of organic compounds, including cellulose, hemicellulose, and lignin, which can be converted into value-added products through various technological processes. SCG have emerged as a promising raw material for biofuel production due to their availability, high energy content, and beneficial chemical composition. A comparable higher heating value of SCG (25 kilojoules per kilogram (kJ/kg)) in comparison to coal renders it an attractive source of thermal energy. Harnessing thermal energy of SCG and investigating its potential as an alternative to fossil fuels is being explored.

There are several pathways through which SCG can be converted into biofuels, including biodiesel production, bioethanol production, pyrolysis, and direct combustion. Among these, pyrolysis stands out as a promising technology capable of converting SCG into biochar, bio-oil, and syngas. During pyrolysis, SCG undergo a thermochemical decomposition process at elevated temperatures (typically ranging from 300 to 700° C.) in an oxygen-free environment. This process results in the generation of bio-oil, syngas, and biochar as primary products. Bio-oil can serve as a renewable liquid fuel, and syngas, primarily composed of hydrogen and carbon monoxide, can be utilized for energy generation or further chemical synthesis. Additionally, biochar can enhance soil properties and contribute to carbon sequestration, thereby promoting environmental sustainability.

Catalytic pyrolysis of SCG may be used to improve the quality of pyrolysis products and reduce acidity, and oxygen and water content in bio-oil. The catalytic pyrolysis process involves the use of catalysts to break down the organic material more efficiently, resulting in a bio-oil with improved chemical properties. Catalysts may help to lower oxygen content in a bio-oil product, which may reduce acidity and water content, leading to a more stable and higher-quality bio-oil.

Several types of catalysts have been investigated for the catalytic pyrolysis of SCG, including zeolites and metal oxides [H. Vu Ly, et al., Catalytic pyrolysis of spent coffee waste for upgrading sustainable bio-oil in a bubbling fluidized-bed reactor: Experimental and techno-economic analysis, Chemical Engineering Journal, 2022, 427]. Zeolites and metal oxide catalysts, such as titanium oxide (TiO₂), have been used in catalytic pyrolysis of various biomass feedstocks due to their ability to enhance the selectivity and yield of desired products. These catalysts play a role in optimizing the pyrolysis process by promoting the formation of valuable chemicals while minimizing unwanted by-products.

While the use of SCG as a potential raw material for fuel production has been explored, the catalytic pyrolysis of SCG has may be improved. Accordingly, an object of the present disclosure is directed towards the utilization of materials such as ZSM-5, gallium (Ga) impregnated ZSM-5, TiO₂, and KOH as catalysts for catalytic pyrolysis of SCG, particularly using microwave-assisted pyrolysis, that may circumvent the drawbacks of the present art.

### SUMMARY

In an exemplary embodiment, a method of conversion of spent coffee grounds (SCG) waste into bio-oil using a catalytic microwave-assisted pyrolysis (MAP) approach is described. The method includes mixing coffee grounds, silicon carbide granules, and a catalyst to form a mixture. A ratio of the mass of the coffee grounds to the mass of the catalyst is from 10:1 to 20:1. The method further includes irradiating the mixture in microwave pyrolysis reactor, resulting in the formation of a product that consists of a first vapor, a second vapor, and char. The method further includes condensing the first vapor to produce the biofuel.

In some embodiments, the catalyst includes a calcined zeolite (ZSM-5) and a gallium dopant.

In some embodiments, the catalyst includes the gallium dopant in an amount of 2 to 6 weight percent (wt. %) based on a total weight of the catalyst.

In some embodiments, the method further includes microwave irradiation at a first power output of 800 to 1000 W per 15 grams of coffee grounds for 1 to 10 minutes.

In some embodiments, the method further includes microwave irradiation at a second power output of 50 to 200 W per 15 grams of coffee grounds for 10 to 30 minutes.

In some embodiments, an amount of biofuel produced is 5 to 45 weight percent (wt. %) based on an initial weight of the coffee grounds.

In some embodiments, the biofuel includes amphetamines, esters, guanidine, alcohols, lactones, pyrroles, heterocycles, fatty acids, ketones, alkenes, xanthine, alkanes, and phenols.

In some embodiments, a method of making the catalyst is described. The method includes dissolving a zeolite Socony mobil-5 (ZSM-5) in water to form a first solution, dissolving a gallium salt in water to form a second solution, mixing the first solution and the second solution to form a third solution, evaporating the water from the third solution at a temperature of 40 to 60° C., drying the third solution at a temperature of 70 to 90° C. to form a product, and calcinating the product at a temperature of 500 to 600° C. to form the catalyst.

In some embodiments, the ZSM-5 has a SiO₂: Al₂O₃ ratio of 20:1 to 40:1.

In some embodiments, the method includes mixing the first solution in an inert environment.

In some embodiments, an inert gas in the inert environment flows at a rate of 60 to 100 mL/min.

In some embodiments, the method includes mixing the first solution and the second solution in a quartz pyrolysis reactor.

In some embodiments, the quartz pyrolysis reactor is connected in sequence to a heating line, a condensing line, and a collector.

In some embodiments, the method includes drying the coffee grounds at a temperature of 100 to 140° C. for 20 to 28 hours before the mixing.

In some embodiments, a weight ratio of the coffee grounds to the catalyst is 10:1 to 20:1.

In some embodiments, a weight ratio of the silicon carbide granules to the coffee grounds is 20:1 to 40:1.

In some embodiments, the coffee grounds are spent coffee ground.

In some embodiments, a pyrolysis temperature is 400 to 600° C.

In some embodiments, the method further includes separating the silicon carbide granules from the char and the catalyst, washing the silicon carbide granules with a non-polar organic solvent, and drying the silicon carbide granules.

In some embodiments, the biofuel comprises 15 to 20% diesel and 70 to 75% gasoline based on a total weight of the biofuel.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a flowchart depicting a method of producing biofuel, according to certain embodiments.

FIG. 1B is a flowchart depicting a method of making a catalyst, according to certain embodiments.

FIG. 1C depicts an experimental set up of a microwave pyrolysis rector, according to certain embodiments.

FIG. 2 shows an elemental analysis, a proximate analysis, and a higher heating value (HHV) of spent coffee grounds (SCG), according to certain embodiments.

FIG. 3 depicts a thermogravimetric analysis (TGA) curve of SCG, according to certain embodiments.

FIG. 4 is a plot of N₂ adsorption-desorption isotherms of Z30 and GaZ30, according to certain embodiments.

FIG. 5 depicts X-ray diffraction (XRD) patterns of GaZ30 and Z30, according to certain embodiments.

FIG. 6A is a scanning electron microscopy (SEM) with energy-dispersive X-ray spectroscopy (EDS) analysis of Z30, according to certain embodiments.

FIG. 6B is an SEM-EDS analysis of GaZ30, according to certain embodiments.

FIG. 7 shows the effect of different catalysts on product yield, according to certain embodiments.

FIG. 8 depicts a simulated distillation (SimDist) analysis of oil samples obtained by utilizing different catalysts, according to certain embodiments.

FIG. 9 depicts proton nuclear magnetic resonance (¹H NMR) spectra for pyrolysis oil, according to certain embodiments.

FIG. 10 depicts Fourier-transform infrared (FTIR) spectra of bio-oil samples obtained with different catalysts, according to certain embodiments.

FIG. 11 depicts gas chromatography-mass spectrometry (GC-MS) analysis of bio-oil samples obtained with different catalysts, according to certain embodiments.

FIG. 12 is a schematic illustration depicting the reaction mechanism and pathway of the SCG degradation during pyrolysis, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or like reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The use of the terms “include,” “includes,” “including,” “have,” “has,” or “having” should be generally understood as open-ended and non-limiting unless specifically stated otherwise.

As used herein, the term “zeolitic material” refers to a material having a crystalline structure or three-dimensional framework of, but not necessarily the elemental composition of, a zeolite. Zeolites are porous silicate or aluminosilicate minerals that occur in nature. Elementary building units of zeolites are SiO₄ (and AlO₄, if appropriate)tetrahedra. Adjacent tetrahedra are linked at their corners via a common oxygen atom, which results in an inorganic macromolecule with a three-dimensional framework (frequently referred to as the zeolite framework). The three-dimensional framework of a zeolite also includes channels, channel intersections, and/or cages having dimensions in the range of 0.1-10 nanometers (nm), preferably 0.2-5 nm, and more preferably 0.2-2 nm. Water molecules may be present inside these channels, channel intersections, and/or cages. Zeolites that are devoid of aluminum may be referred to as “all-silica zeolites” or “aluminum-free zeolites.” Some zeolites that are substantially free of, but not devoid of, aluminum are called “high-silica zeolites.” Sometimes, the term “zeolite” is used to refer exclusively to aluminosilicate materials, excluding aluminum-free zeolites or all-silica zeolites.

In some embodiments of the current disclosure, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g., gonnardite, natrolite, mesolite, paranatrolite, scolecite, and tetranatrolite), edingtonite framework (e.g., edingtonite and kalborsite), thomsonite framework, analcime framework (e.g., analcime, leucite, pollucite, and wairakite), phillipsite framework (e.g., harmotome), gismondine framework (e.g., amicite, gismondine, garronite, and gobbinsite), chabazite framework (e.g., chabazite-series, herschelite, willhendersonite, and SSZ-13), faujasite framework (e.g., faujasite-series, Linde type X, and Linde type Y), mordenite framework (e.g., maricopaite and mordenite), heulandite framework (e.g., clinoptilolite and heulandite-series), stilbite framework (e.g., barrerite, stellerite, and stilbite-series), brewsterite framework, cowlesite framework, mixtures thereof, or any other framework known in the art. In some embodiments, the porous silicate and/or aluminosilicate matrix is a zeolitic material having a zeolite framework selected from the group comprising ZSM-5, ZSM-8, ZSM-11, ZSM-12, ZSM-18, ZSM-23, ZSM-35, and ZSM-39. In some embodiments, the zeolitic material may be any zeolitic material known in the art.

As used herein, the words “about,” “approximately,” or “substantially similar” may be used when describing magnitude and/or position to indicate that the value and/or position described is within a reasonably expected range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the staled value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

Aspects of the present disclosure pertain to a microwave-assisted pyrolysis (MAP) method employed to convert spent coffee grounds (SCG) into bio-oil. The method utilizes various catalysts, including ZSM-5, Ga-impregnated ZSM-5, potassium hydroxide, and titanium oxide, to improve the quality and yield of the resultant products. The bio-oil generated through the method of present disclosure holds potential for producing valuable chemical compounds and liquid fuels, presenting an advantageous solution for coffee waste management.

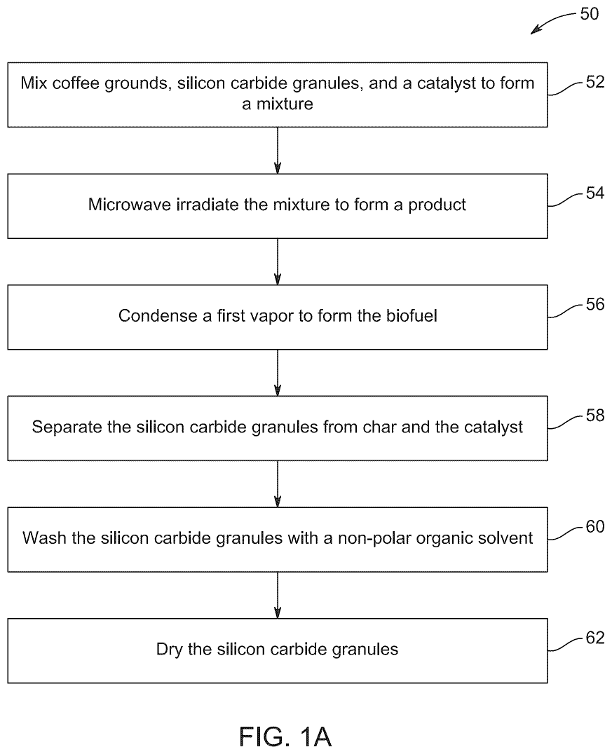

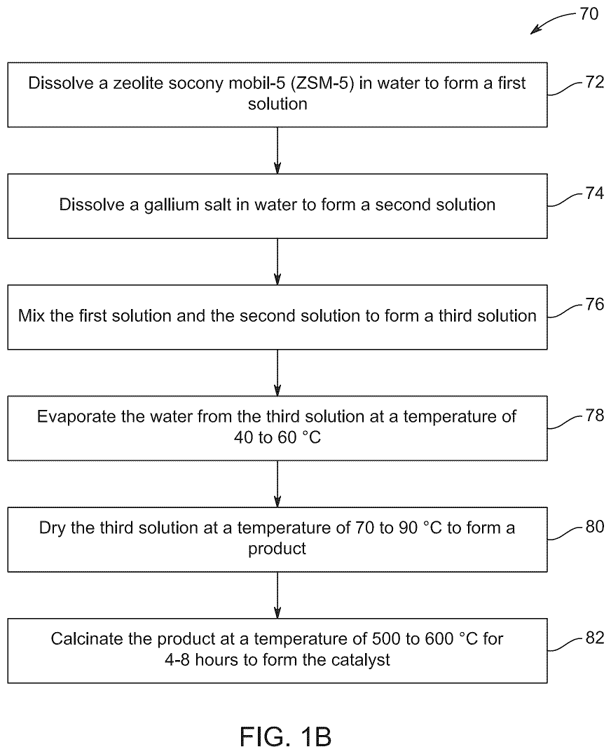

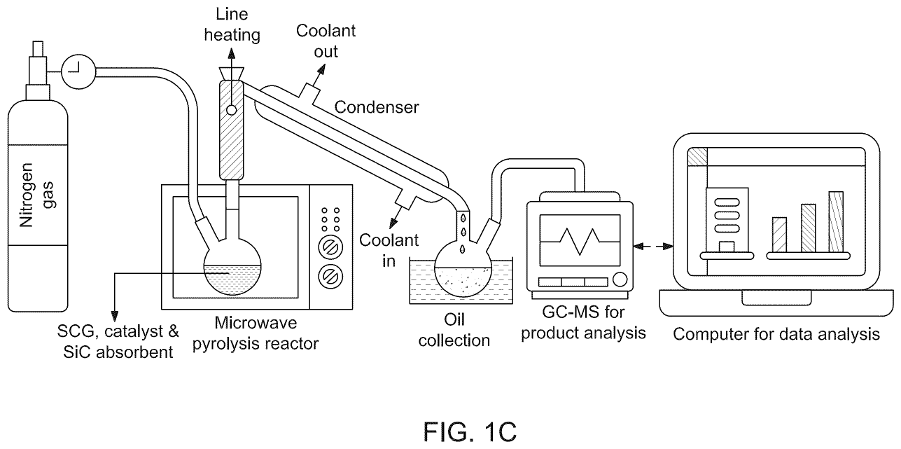

FIG. 1A illustrates a flowchart of a method 50 of producing a biofuel. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes mixing coffee grounds, silicon carbide granules, and a catalyst to form a mixture. In an embodiment, the coffee grounds are spent coffee grounds. In some embodiments, the coffee grounds include a mixture of fresh and spent coffee grounds. In some embodiments, proximate analysis of the spent coffee grounds shows that the spent coffee grounds have greater than 50%, preferably greater than 55%, preferably greater than 60%, preferably greater than 65%, preferably greater than 70%, preferably greater than 75%, and preferably greater than 80% of volatile organic matter. In some embodiments, elemental analysis of the spent coffee grounds include carbon in the range of 50-60%, preferably 51-58%, more preferably 52-55%, and yet more preferably about 53%, and hydrogen in the range of 1-10%, preferably 2-9%, more preferably 4-8%, and yet more preferably about 6%. In some embodiments, the spent coffee grounds include 30-40%, preferably 32-39%, preferably 35-38%, and yet more preferably about 38% oxygen. In some embodiments, the spent coffee grounds may be dried at a temperature of 80-150° C., preferably 90-140° C., more preferably 100-130° C., and yet more preferably about 120° C. for a time sufficient to reduce the moisture content to less than 30%, preferably less than 28%, preferably less than 25%, preferably less than 20%, preferably less than 20%, preferably less than 15%, or preferably less than 10%. In some embodiments, the spent coffee grounds may be heated to a temperature of 120° C. for about 12-30 hours, preferably 15-28 hours, more preferably 22-26 hours, and yet more preferably about 24 hours to remove moisture.

The silicon carbide granules are a microwave absorbent. Optionally, other microwave adsorbents, such as silica, activated carbon, carbon fibers, clay minerals, and the like, can also be used in place of or in combination with the silicon carbide granules. In some embodiments, a weight ratio of the silicon carbide granules to the coffee grounds is 20:1 to 40:1, preferably 22:1 to 39:1, preferably 24:1 to 38:1, preferably 26:1 to 37:1, preferably 28:1 to 36:1, preferably 30:1 to 35:1, more preferably 32:1 to 34:1, and yet more preferably about 33:1. In other embodiments, other ranges are also possible, and such ranges may be determined by a person skilled in the art.

The catalyst includes a calcined ZSM-5 (also referred to as Z30) and a gallium dopant (also called Ga-impregnated ZSM-5 or Ga-doped ZSM-5 or GaZ30). The coffee grounds and the catalyst are mixed in a weight ratio of 10:1 to 20:1, preferably 11:1 to 19:1, preferably 12:1 to 18:1, preferably 13:1 to 17:1, more preferably 14:1 to 16:1, and yet more preferably about 15:1. The catalyst includes the gallium dopant in an amount of 2 to 6 wt. %, preferably 3 to 5.5 wt. %, more preferably 4 to 5.2 wt. %, and yet more preferably about 5 wt. % based on the total weight of the catalyst. Other catalysts such as ZSM-5, potassium hydroxide (KOH), titanium dioxide (TiO₂), calcium carbonate (CaCO₃), aluminum oxide (Al₂O₃), zeolite beta, silica-alumina, molybdenum sulfide (MOS₂), and nickel-based catalysts may also be used in place of or in combination with the Ga-doped ZSM-5. In some embodiments, the Ga-impregnated ZSM-5 catalyst includes oxygen (O) in an amount of 50 to 70 percent by weight (wt. %), preferably 55 to 65 wt. %, more preferably 57 to 62 wt. %, and yet more preferably about 59.86 wt. %, silicon (Si) in an amount of 25 to 35 wt. %, preferably 28 to 35 wt. %, more preferably 30 to 34 wt. %, and yet more preferably about 33.82 wt. %, aluminum (Al) in an amount of 1 to 5 wt. %, preferably 2 to 4 wt. %, more preferably 2 to 3 wt. %, and yet more preferably about 2.34 wt. %, and gallium (Ga) in an amount of 1 to 5 wt. %, preferably 2 to 4.5 wt. %, more preferably 3 to 4 wt. %, and yet more preferably about 3.92 wt. % based on a total weight of the catalyst.

The reactants are mixed in an inert environment (in the presence of an inert gas) with a flow rate of 60 to 100 mL/min, preferably 65 to 95 mL/min, preferably 70 to 90 mL/min, more preferably 75 to 85 mL/min, and yet more preferably 80 mL/min. The inert gas may include, but is not limited to, argon (Ar), helium (He), and nitrogen (N₂), mixtures thereof, and the like. In a preferred embodiment, N₂ is used as the inert gas.

The reactants are mixed in a quartz pyrolysis reactor. The quartz pyrolysis reactor is connected sequentially to a heating line, a condensing line, and a collector. The heating line delivers controlled, high-temperature heat to the quartz reactor for effective pyrolysis. The condensing line cools and condenses the pyrolysis gases into liquid form using a heat exchanger or cooling coils. The collector gathers the condensed liquids and residual solids for analysis or further use. In some embodiments, other reactors, for example, tube furnace reactors, fluidized bed reactors, screw-conveyor reactors, liquefaction autoclave reactors, catalytic bubbling fluidized-bed reactors, and the like may also be used. The temperature in the pyrolysis reactor is maintained at a temperature of 400 to 600° C., preferably 450 to 590° C., more preferably 480 to 580° C., and yet more preferably about 550° C. Pyrolysis is a chemical process in which organic materials, such as spent coffee grounds, decompose at elevated temperatures without oxygen. This thermal degradation breaks down complex molecules into simpler compounds, typically forming gases, liquids (known as bio-oil or tar), and/or solid residues (such as char or carbon).

At step 54, the method 50 includes microwave irradiating the mixture to form a product. In some embodiments, the microwave irradiation is carried out at a first power output of 800 to 1000 W, preferably 825 to 975 W, preferably 850 to 950 W, more preferably 875 to 925 W, and yet more preferably about 900 W per 15 grams of coffee grounds for 1 to 10 minutes, preferably 2 to 9 minutes, preferably 3 to 8 minutes, more preferably 4 to 6 minutes, and yet more preferably about 5 minutes. In some embodiments, the microwave irradiation is carried out at a second power output of 50 to 200 W, preferably 60 to 170 W, preferably 80 to 120 W, more preferably 90 to 110 W, and yet more preferably about 100 W per 15 grams of coffee grounds for 10 to 30 minutes, preferably 12 to 28 minutes, preferably 15 to 25 minutes, more preferably 18 to 22 minutes, and yet more preferably about 20 minutes. In some embodiments, the second power output follows the first power output during the microwave irradiating. In some embodiments, the second power output follows the first power output after an amount of time, including, but not limited to, 1 second, 5 seconds, 10 seconds, 30 seconds, 60 seconds, 2 minutes, 5 minutes, 10 minutes, and any amount of time as determined by a person skilled in the art. In a preferred embodiment, the microwave is an MCR-3SX-type microwave chemical reactor. Optionally, milestone startsynth, anton paar monowave 300, cem mars 6, biotage initiator+, SINEO microwave chemical reactor, helium reactor, SPECS microwave reactor, and any microwave reactor known in the art may also be used instead of MCR-3SX type microwave chemical reactor. Microwave irradiation results in volatilization of the volatile components in the mixture, forming a product. The product includes a first vapor, a second vapor, and a char. The first vapor includes the biofuel. After being used in this reaction to form the product, the catalyst is referred to as a spent catalyst.

At step 56, the method 50 includes condensing the first vapor to form the biofuel. Condensation is when a gas or vapor transitions into a liquid or solid state upon cooling or compression. This phase change occurs when the temperature of the vapor decreases below its dew point or when the vapor pressure reaches the saturation pressure. In some embodiments, other methods used or known in the art can also be used for condensing the first vapor to form the biofuel.

In some embodiments, the amount of biofuel produced is 5 to 45 weight percent (wt. %), preferably 10 to 40 wt. %, preferably 15 to 35 wt. %, more preferably 25 to 30 wt. %, and yet more preferably about 29 wt. % based on the initial weight of the coffee grounds. In some embodiments, the biofuel includes about 15 to 20% diesel and 70 to 75% gasoline based on the total weight of the biofuel. Examples of the organic compounds present in the biofuel include amphetamines, esters, guanidines, alcohols, lactones, pyrroles, heterocycles, fatty acids, ketones, alkenes, xanthine, alkanes, phenols, and the like. In some embodiments, the biofuel produced includes 60 to 80 wt. %, preferably 63 to 77 wt. %, preferably 65 to 75 wt. %, more preferably 68 to 72 wt. %, and yet more preferably about 70.43 wt. % C, 5 to 15 wt. %, preferably 7 to 13 wt. %, preferably 8 to 12 wt. %, more preferably 9 to 11 wt. %, and yet more preferably about 10.32 wt. % H, 5 to 20 wt. %, preferably 10 to 19 wt. %, more preferably 14 to 18 wt. %, and yet more preferably about 16.64 wt. % O, 1 to 5 wt. %, preferably 1.5 to 4 wt. %, more preferably 2 to 3 wt. %, and yet more preferably about 2.55 wt. % N, and 0.01 to 1 wt. %, preferably 0.02 to 0.2 wt. %, more preferably 0.03 to 0.08 wt. %, and yet more preferably about 0.06 wt. % S.

At step 58, the method 50 includes separating the silicon carbide granules from the char and the catalyst. The spent catalyst and char can be separated from the silicon carbide granules through mesh sieving. In some embodiments, other methods used or known in the art can also be used. The silicon carbide granules are further regenerated by methods known in the art. In some embodiments, the silicon carbide granules are regenerated by the following steps.

At step 60, the method 50 includes washing the silicon carbide granules with a non-polar organic solvent. In some embodiments, the non-polar organic solvent may include, but is not limited to, hexane, benzene, toluene, diethyl ether, chloroform, cyclohexane, carbon tetrachloride, xylene, and the like. In a preferred embodiment, the non-polar organic solvent is toluene.

At step 62, the method 50 includes drying the silicon carbide granules. In some embodiments, the drying can be performed by using heating appliances such as ovens, microwaves, autoclaves, hot plates, heating mantles and tapes, oil baths, salt baths, sand baths, air baths, hot-tube furnaces, hot-air guns, and the like. In a preferred embodiment, silicon carbide granules are dried at 100 to 150° C., preferably 105 to 140° C., more preferably 110 to 130° C., and yet more preferably about 120° C. in an oven, for example, a convection oven.

FIG. 1B illustrates a schematic flow chart of a method 70 of making the catalyst. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes dissolving a Zeolite Socony Mobil-5 (ZSM-5) in water to form a first solution. In some embodiments, the ZSM-5 has a SiO₂: Al₂O₃ ratio of 20:1 to 40:1, preferably 22:1 to 38:1, preferably 24:1 to 36:1, preferably 26:1 to 34:1, more preferably 28:1 to 32:1, and yet more preferably about 30:1. The water may be tap water, distilled water, bi-distilled water, deionized water, deionized distilled water, reverse osmosis water, hard water, fresh water, brine/salt water, hard water, freshwater, and any water known in the art. In a preferred embodiment, the water is deionized water. In some embodiments, the weight-by-volume (w/v) ratio of the ZSM-5 to water is in the range of 1:1 to 1:20, preferably 1:2 to 1:18, preferably 1:3 to 1:15, more preferably 1:5 to 1:12, and yet more preferably about 1:10. In some embodiments, the first solution is stirred at 500 rotations per minute (rpms) on a magnetic heating plate.

At step 74, the method 70 includes dissolving a gallium salt in water to form a second solution. Suitable examples of gallium salts include, but are not limited to, gallium sulfate, gallium nitrate, gallium chloride, and the like. In some embodiments, the hydrated salts of the gallium salts may also be used. In a preferred embodiment, the gallium salt is gallium nitrate. In some embodiments, the concentration of the gallium salt in the second solution is in the range of 1-10%, preferably 2-9%, preferably 3-8%, preferably 4-7%, more preferably 5-6%, and yet more preferably about 5%.

At step 76, the method 70 includes mixing the first solution and the second solution to form a third solution. The first and second solutions are mixed at room temperature for 1-5 hours (h), preferably 2-4 h, and more preferably about 3 hours.

At step 78, the method 70 includes evaporating the water from the third solution at a temperature of 40 to 60° C., preferably 43 to 57° C., preferably 45 to 55° C., more preferably 48 to 52° C., and yet more preferably about 50° C.

At step 80, the method 70 includes drying the third solution at a temperature of 70 to 90° C., preferably 73 to 87° C., preferably 75 to 85° C., more preferably 78 to 82° C., and yet more preferably 80° C. for 5-15 h, preferably 7-13 h, and more preferably about 12 h, to form a product.

At step 82, the method 70 includes calcinating the product at a temperature of 500 to 600° C., preferably 520 to 580° C., more preferably 540 to 560° C., and yet more preferably about 550° C. for 4-8 hours, preferably 4-7 hours, more preferably 4.5 to 6 hours, and yet more preferably about 5 hours to form the catalyst. In some embodiments, the catalyst has a BET surface area of 300-400 m²/g, preferably 310-350 m²/g, more preferably 315-330 m²/g, and yet more preferably about 316 m²/g. In some embodiments, the catalyst has a micropore area of 200-210 m²/g, preferably 202-208 m²/g, more preferably 203-205 m²/g, and yet more preferably about 204 m²/g. In some embodiments, the catalyst has a total pore volume of 0.01 to 0.5 cm³/g, preferably 0.05 to 0.2 cm³/g, more preferably 0.1 to 0.15 cm³/g, and yet more preferably about 0.132 cm³/g. In some embodiments, the catalyst has a micropore volume of 0.05 to 0.15 cm³/g, preferably 0.06 to 0.14 cm³/g, more preferably 0.07 to 0.12 cm³/g, and yet more preferably about 0.11 cm³/g. In some embodiments, the catalyst has a mesopore volume of 0.01 to 0.04 cm³/g, preferably 0.015 to 0.035 cm³/g, more preferably 0.02 to 0.03 cm³/g, and yet more preferably about 0.022 cm³/g. In some embodiments, the total acidity of the catalyst is in the range of 0.5-1.5 mmol/g, preferably 0.75-1.25 mmol/g, and more preferably about 1.119 mmol/g.

### Examples

The following examples demonstrate a method of producing biofuel from spent coffee grounds (SCG) by converting it into bio-oil using a catalytic microwave-assisted pyrolysis (MAP) approach. The examples are provided solely for illustration and are not to be construed as limitations of the present disclosure, as many variations thereof are possible without departing from the spirit and scope of the present disclosure.

### Example 1: Materials and Methods

The SCG (spent coffee grounds) were collected from Starbucks, and any unwanted materials were subsequently removed before drying. Granular silicon carbide served as the microwave absorbent. The zeolite catalyst ZSM-5 (CBV 3024 E), with a SiO₂/Al₂O₃ molar ratio of 30, was supplied by Zeolyst International, USA, and used as the parent zeolite. The 99.99% pure nitrogen (N₂) gas used in the experiment was obtained from KFUPM, Main Store. The metal precursor, gallium nitrate hydrate Ga(NO₃)₃·xH₂O (≥99% purity), was procured from Sigma-Aldrich. Deionized water, with a resistivity of 18.2 MΩ·cm at 25° C., was employed in the preparation of the aqueous solution and generated using a Milli-Q system procured from Sigma-Aldrich. Titanium dioxide (TiO₂) and potassium hydroxide (KOH) was obtained from Sigma-Aldrich.

### Example 2: Catalyst Synthesis of Metal-Doped ZSM-5

The ZSM-5 zeolite utilized and the synthesis of metal-doped ZSM-5 was subjected to calcination at 550° C. for 5 hours before application. The ZSM-5 employed in the current disclosure is termed as Z30. Gallium (Ga) metal was doped onto Z30 using a conventional wet impregnation method with 5% loading. In this method, 5 g of Z30 was dissolved in 50 mL of deionized water in a beaker and stirred at 500 rpms on a magnetic heating plate. Subsequently, the predetermined amount of the Ga precursor (Ga(NO₃)₃·xH₂O) solution was added dropwise to the Z30 solution under continuous stirring. The contents of the beaker were allowed to stir at room temperature for 3 hours. After 3 hours, the temperature of the magnetic heating plate was set to 50° C. to allow water evaporation. Following this, the contents of the beaker were dried at 80° C. for 12 hours. After drying, the contents of the beaker were crushed and ground using a mortar and pestle to obtain a fine powder catalyst. This fine powder catalyst was then subjected to calcination at 550° C. for 5 hours. The resulting Ga-impregnated Z30 catalyst was named GaZ30.

### Example 3: Microwave Pyrolysis Reactor Setup

The pyrolysis was conducted in an MCR-3SX type microwave chemical reactor (Supplier: Zhengzhou Keda Machinery and Instrument Equipment Co. Ltd, Zhengzhou, China), utilizing state-of-the-art technology with an output power of ≤900 W (automatically adjustable frequency) and a frequency of 2450±50 MHz, including a continuous output mode feature. The experimental setup is schematically illustrated in FIG. 1C. The microwave pyrolysis system was developed consisting of four main components: (i) quartz pyrolysis reactor, (ii) a set of temperature controllers (type K thermocouple & IR based) to measure temperature at different points, (iii) a condenser to collect the oil product, and (iv) the microwave reactor, as described above.

The selected SCG feedstock was dried at 120° C. for 24 hours before pyrolysis to remove moisture. High-performance silicon carbide granules were mixed with SCG and the catalyst and placed inside a 250 mL quartz flask. The amount of silicon carbide was fixed at 500 g to absorb microwave radiation. Incorporating around 500 grams of silicon carbide (SiC) absorbent during pyrolysis results in effective absorption of microwave radiation [Ding, K. et al., Catalytic microwave-assisted pyrolysis of plastic waste over NiO and HY for gasoline-range hydrocarbons production, Energy Convers. Manag., 2019, 196, 1316-1325, which is incorporated herein by reference in its entirety]. The high SiC content demonstrated favorable properties for microwave absorption.

For each run, 15 g of SCG was weighed and subsequently mixed with 1 g of the selected catalyst. The weight ratio of the catalyst and feedstock was consistently maintained at 1:15 for all runs. The initial run, conducted without a catalyst, produced minimal liquid oil as condensable gases converted to wax. Therefore, this run was disregarded for further characterization. To minimize heat loss during microwave radiation, the quartz flask was enveloped with glass wool and Teflon tape. Borosilicate glass connectors were employed to link the reactor outlet and the condenser, with the connecting line wrapped in a heating line set to 250° C. using a temperature controller. The purpose of this heating line was to prevent condensation of the pyrolysis vapor within the connecting pipe. The connecting pipe was attached to a condenser, and cooling was achieved using LAUDA MGW RC-20 (Supplier: LAUDA, Germany), providing a reliable, compact, and energy-saving circulation chilling operation. The cooling water temperature was maintained at 10° C. The exit of the condensing line was connected to a round-bottomed collection flask submerged in an ice bath for condensation of condensable gases. All connections and joints were sealed with Teflon tape, and leak tests were conducted to confirm the absence of leaks. A vacuum pump evacuated the system, and inert N₂ gas was introduced to create an oxygen-free environment inside the reactor, preventing side reactions. N₂ gas served not only to purge the reactor but also as a carrier gas for the product vapors. Before operation, the N₂ gas flow rate was set to 80 mL/min and maintained constant. The final exit tube from the oil collection flask was immersed in a water beaker to detect the N₂ flow, confirmed by bubbles.

After ensuring that all conditions were met for the N₂ gas line, heating line, and condensing line, the reactor was initiated. To attain the pyrolysis temperature of 500° C., the microwave reactor operated at its maximum power output (900 W) for an initial five minutes. Given that granular-type high-performance silicon carbide is a good microwave radiation absorber, a heating rate of 60-80° C./min was achieved at the maximum microwave power. Once the desired pyrolysis temperature was reached, the reactor was adjusted to low microwave power (100 W). At this lower power setting, the reaction run time was set to 20 minutes to vaporize volatile components in the SCG sample. The condensable liquid, identified as bio-oil, was collected from the collection flask. Non-condensable gases were not collected. The spent catalyst and char were separated from the absorbent through mesh sieving. Additionally, fine carbon from the absorbent was separated using toluene as a solvent. The wet absorbent was then dried at 120° C. in a forced convection oven (100 L; Model No: JSOF-100, Supplier: JS Research Inc., Gongju-City, Korea). The absorbent was recovered and utilized for subsequent cycles. Each experiment was replicated to support the accuracy and reproducibility of the findings.

The yield of oil, char, and gas was determined using equations 1, 2, and 3, respectively.

$$Oil ( \% ) = \frac{wt . of oil}{wt . of SCG} \times 100 \qquad ( 1 )$$

$$Char ( \% ) = \frac{wt . of char}{wt . of SCG} \times 100 \qquad ( 2 )$$

$$Gas + light end losses ( \% ) = 100 - ( Oil \% + Char \% ) \qquad ( 3 )$$

### Example 3: SCG, Catalyst, and Pyrolytic Bio-Oil Characterization Methods

The properties of the SCG were assessed prior to its utilization in the pyrolysis process. Additionally, ASTM methods 3173 and 3175 were applied to perform the proximate analysis of SCG. Elemental and proximate analyses were conducted to study the composition of the SCG. A CHNS analyzer was employed to determine the carbon, hydrogen, nitrogen, oxygen, and sulfur contents of the SCG. The higher heating value (HHV) of SCG was estimated using a Dulong formula. A thermogravimetric analysis (TGA) analyzer (Model No. SDT Q600, V20.9, Build 20) from National Scientific Company Limited (NSC) was utilized to study the thermal degradation behavior of SCG. The TGA system includes a highly sensitive horizontal balance and furnace capable of reaching temperatures up to 1500° C. from ambient temperature. An alumina pan was employed to hold 15 mg of SCG. A N₂ flow rate of 50 ml/min was maintained throughout the operation, and the temperature ramp was set at 10° C./min, starting from room temperature and reaching 700° C.

A Shimadzu GC Model 2020 gas chromatograph equipped with a flame ionization detector (FID) was employed to conduct the simulated distillation (SimDist) of the pyrolysis oil samples. SimDist, a chromatographic procedure, was utilized to correlate retention times with boiling points. The detector temperature was consistently maintained at 400° C. The GC column temperature was programmed as follows: initially held at 40° C. for 2 minutes, then ramped at a heating rate of 5° C./min to reach 380° C. High-purity nitrogen gas served as the carrier gas with a flow rate of 10 mL/min, and 1 μL of the diluted sample was introduced into the injector (350° C.). The capillary column (MXT 2887) possessed a diameter of 0.53 mm and a length of 10 m.

Gas chromatography (GC-6890N/5975B MSD) analysis was conducted using an instrument from Agilent Technologies to identify the chemical compounds present in the produced oil. The oil sample was initially diluted with chloroform, and 1 μL of the diluted sample was introduced into the analytical instrument. The instrument was programmed to run for 50 minutes, with an initial oven temperature set at 60° C. for 5 minutes, followed by a ramp rate of 5° C./min up to 250° C., and a holding time of 5 minutes. The injector was configured with a temperature of 280° C., a pressure of 1.06 psi, and a total flow rate of 10.4 mL/min. Helium gas was consistently supplied throughout the analysis, and the split ratio was maintained at 5:1.

Proton nuclear magnetic resonance (¹H NMR) analysis of the oil sample was carried out utilizing a JEOL 600 MHz NMR spectrometer (JEOL USA, Inc.). Deuterated toluene served as the deuterated solvent in ¹H NMR. The oil sample was dissolved in CDCl₃, and the resulting solution was transferred to a standard 5 mm NMR tube. Subsequently, the ¹H-NMR spectra were obtained and processed using Mestre Nova software. This involved Fourier transformation with a line broadening of 1 Hz, manual phase correction, and baseline correction using the Bernstein polynomial technique.

Functional groups present in the pyrolysis oil were identified through Fourier-transform infrared (FTIR) analysis conducted with a Nicolet 6700 model instrument supplied by Naizak Global Engineering Systems. A KBr pellet was utilized to mount a drop of the oil, and IR spectra were recorded in the range of 4000 wavenumbers (cm⁻¹) to 400 cm⁻¹. The Z30 and GaZ30 catalysts underwent various characterization techniques to assess their properties. Powder X-ray diffraction (XRD) analysis for both catalysts was conducted using the Rigaku Miniflex II benchtop diffractometer. The scanning rate was set at 0.02, covering a range of 5-60° 2θ with a scan rate of 20°/min.

N₂ adsorption-desorption isotherms were generated using the Micromeritics ASAP-2020 apparatus at a liquid N₂ temperature of 195° C. Prior to analysis, both catalyst samples underwent exposure to high vacuum at 220° C. for 80 minutes for degassing. Brunauer-Emmett-Teller (BET) analysis was performed the determine the specific surface area, pore volume, and average pore size. Micropore surface area and volume were determined using the T-Plot technique. Scanning electron microscopy (SEM) was employed to investigate the morphological features of Z30 and GaZ30, with SEM imaging performed at 20 kV. Elemental composition of the catalysts was assessed through energy-dispersive X-ray spectroscopy (EDX) analysis facilitated by LINK INCA software on a Lyra 3 instrument. To estimate the acidity of Z30 and GaZ30 catalysts, NH₃ temperature programmed desorption (NH₃-TPD) experiments were conducted using a BELCAT system. Both catalysts were heated to 500° C. in the presence of He with a flow rate of 50 mL/min for approximately 1 hour. Subsequently, they were allowed to cool to ambient temperature. Acid sites were saturated by supplying a mixture of 5% NH₃ in He at 100° C. for 30 minutes. Lightly attached NH₃ was removed at 120° C. using He at a flow rate of 50 mL/min for 2 hours. The samples were then cooled to room temperature, and the furnace temperature was incrementally raised from 100 to 600° C. with a heating rate of 10° C./min using a He at a flow rate of 25 mL/min. The quantity of released NH₃ was measured using a thermal conductivity detector (TCD). All analyzers were calibrated using standard values.

### Example 4: Characteristics of SCG; Proximate, Elemental Analysis and High Heating Value (HHV) of SCG

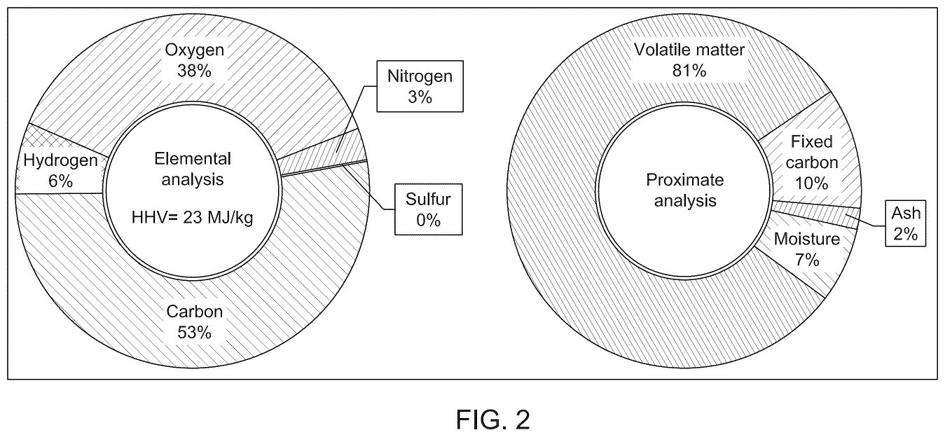

FIG. 2 illustrates the proximate analysis of SCG. In the proximate analysis, the presence of volatile matter in SCG is high, with a value of approximately 81%. The existence of a high volatile matter content in any carbonaceous material results in the formation of liquid and gas products during thermochemical conversion processes, such as pyrolysis and thermal liquefaction. The moisture content in the SCG sample was estimated to be around 7%. Elevated moisture content reduces the calorific value of the liquid produced through thermochemical processes. Minimizing moisture content in a sample enhances the energy density of a pyrolytic fuel oil. Fixed carbon in SCG was estimated to be approximately 10%. A high fixed carbon value contributes to the formation of solid residue in the process. The ash formation in SCG is around 2%.

The elemental analysis of SCG and its HHV are also presented in FIG. 2. The carbon and hydrogen contents in the SCG sample were estimated to be approximately 53% and 6%, respectively. Based on the findings, carbon and oxygen were identified as the predominant elements in the SCG. The presence of carbon and hydrogen in any carbonaceous material plays a role in determining its energy density, specifically in terms of HHV. Higher carbon and hydrogen contents contribute to an enhanced HHV of the fuel. According to the results, the oxygen content in SCG was estimated to be around 38%. This elevated oxygen presence may be attributed to the presence of complex carbohydrates (cellulose, hemicellulose, and lignin). The oxygen content has the potential to reduce the HHV of SCG. Consequently, the HHV of SCG is estimated to be approximately 23 MJ/kg, which is low when compared to conventional solid fuels such as coal. Discrepancies observed may be attributed to variations in origin, brand, manufacturing processes, and coffee quality.

### Example 5: TGA Analysis of SCG

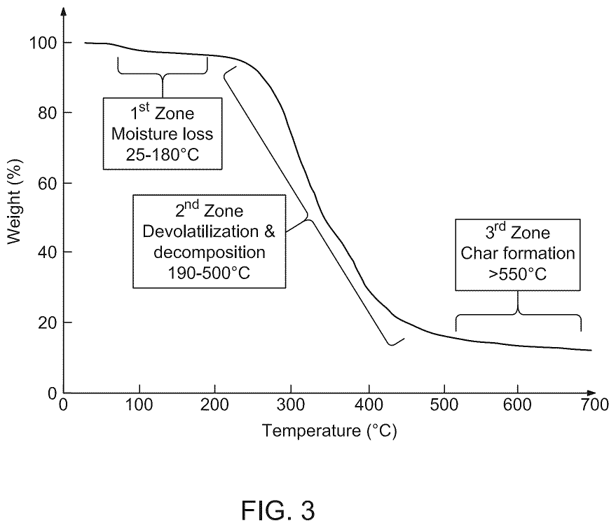

FIG. 3 illustrates the thermal degradation of SCG concerning temperature and percentage weight loss in the form of a thermogravimetric analysis (TGA) curve. The thermal degradation of SCG occurred in three stages. In the first stage, a gradual weight loss (˜5%) of the SCG sample is observed between 25° C. and 180° C., attributed to the loss of moisture content in the sample. The second stage of the TGA curve, ranging from 190° C. to 500° C., represents a pyrolytic zone involving the main complex reactions. During this stage, various volatiles and organic compounds such as cellulose, hemicellulose, and lignin decompose and are released from the SCG, contributing to approximately 80% of the total weight loss. Hemicellulose primarily undergoes thermal decomposition at low temperatures, typically ranging from 200° C. to 350° C., releasing volatile compounds. Cellulose decomposition occurs at higher temperatures, between 260° C. and 430° C., involving the breakdown of semi-volatile compounds. Lignin decomposition takes place over a broader temperature range, spanning from 200° C. to 500° C. From 500° C. to 700° C., the weight of the SCG sample to decreases from 17% to 12%, attributed to the degradation of woody biomass and lignin structures, which may be a contributor to the final mass of char (solid residue). As seen in the TGA graph, it can be inferred that SCG primarily consists of cellulose and hemicellulose. Up to 500° C., approximately 80% of the initial mass has undergone thermal decomposition and devolatilization, indicating a high presence of volatile matter. This finding aligns with the proximate analysis. Consequently, conducting pyrolysis of SCG at temperatures around 400-600° C. would be appropriate to achieve the maximum conversion of SCG under different conditions. Based on TGA analysis and considering the catalyst's activity, the pyrolysis temperature for the catalytic pyrolysis of SCG was set to 550° C.

### Example 6: Characterization of Catalyst GaZ30; by BET, N₂ Adsorption-Desorption Isotherms, and NH₃-TPD Analysis

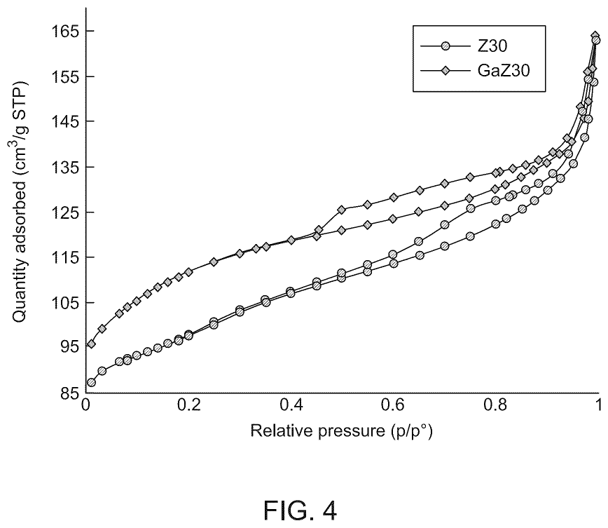

The GaZ30 catalyst, along with the parent Z30 catalyst, underwent BET analysis, and the results are presented in Table 1. The BET surface area of Ga-impregnated Z30 decreased with the addition of 5% Ga loading. The BET surface area of the parent Z30 was estimated to be 342 m²/g, while the BET surface area of Ga-impregnated Z30 (GaZ30) was estimated to be 316 m²/g. The same trend was observed for the total pore volume, where the pore volume of GaZ30 was less than that of the parent Z30. The total pore volume of Z30 was estimated to be 0.17 cm³/g and 0.132 cm³/g for GaZ30. This reduction in surface area and total pore volume may be attributed to the loading of Ga onto the parent Z30 structure resulted in a blocking or partial blocking of pores within the zeolite framework. The Ga particles occupied the pore spaces, thereby reducing the overall available surface area and total pore volume for adsorption. NH₃-TPD analysis of both parent Z30 and GaZ30 was conducted to assess the total acidity as well as weak (100-350° C.) and strong acidity (350-690° C.) regions, and the results are presented in Table 1. The total acidity of parent Z30 was found to be 1.095 NH₃ mmol/g. The weak and strong acidities of Z30 were found to be 0.657 NH₃ mmol/g and 0.438 NH₃ mmol/g, respectively. The total acidity of GaZ30 was estimated to be 1.119 NH₃ mmol/g, with weak and strong acidities of 0.716 NH₃ mmol/g and 0.403 NH₃ mmol/g, correspondingly. FIG. 4 presents the N₂ adsorption-desorption isotherms for GaZ30 and Z30. Both catalyst isotherms fall under the type I.

TABLE 1
BET analysis of GaZ30 and parent Z30

| | | |
|---|---|---|
| Property | Z30 | GaZ30 |

Surface area

| | | |
|---|---|---|
| S_{BET} (m²/g) | 342 | 316 |
| t-Plot Micropore Area (m²/g) | 210 | 204 |
| t-Plot External Surface Area (m²/g) | 133 | 112 |

Pore volume

| | | |
|---|---|---|
| Vₜₒₜₐₗ (cm³/g) | 0.17 | 0.132 |
| V_{micro} (cm³/g) | 0.112 | 0.11 |
| Vₘₑₛₒ (cm³/g) | 0.058 | 0.022 |
| Vₘₑₛₒ/V_{micro} | 0.518 | 0.2 |

NH₃-TPD results

| | | |
|---|---|---|
| Total Acidity (NH₃ mmol/g) | 1.095 | 1.119 |
| Weak acidity (100-350° C.) | 0.657 | 0.716 |
| Strong acidity (350-690° C.) | 0.438 | 0.403 |

### Example 7: XRD Analysis of GaZ30 and Parent Z30

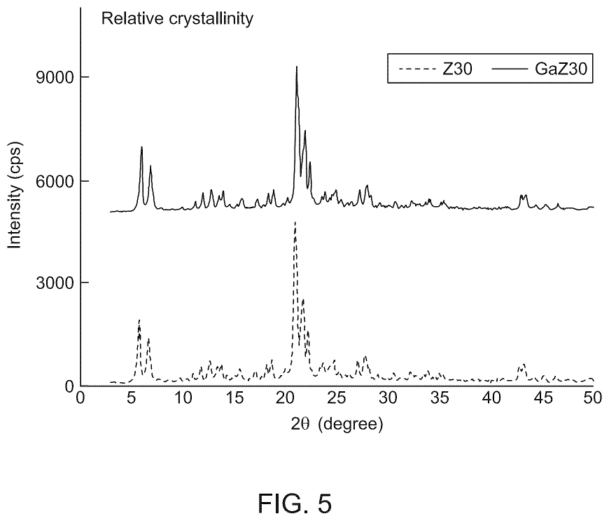

FIG. 5 shows XRD peaks obtained after analysis of GaZ30 and parent Z30. The XRD analysis of the synthesized GaZ30 catalyst and Z30 was conducted to investigate the crystallographic structure of the catalyst material. The XRD peaks for both catalysts exhibited a high degree of similarity, with intense diffraction peaks identified at 5.7°, 6.7°, 20.9°, 21.9°, and 22.4°. No diffraction peaks associated with oxides due to the 5% Ga impregnation on Z30 were observed. This phenomenon may be due to the uniform and finely distributed Ga on the Z30 support, leading to a structure that may lack sufficient crystallinity to yield discernible diffraction patterns.

### Example 8: SEM Analysis of Synthesized GaZ30

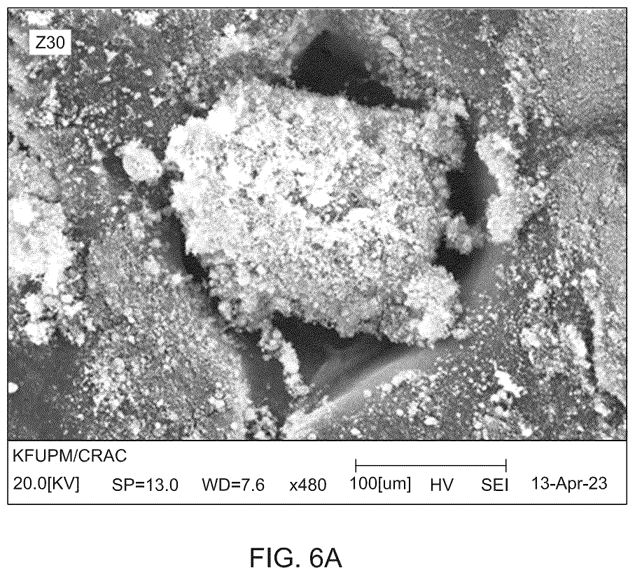

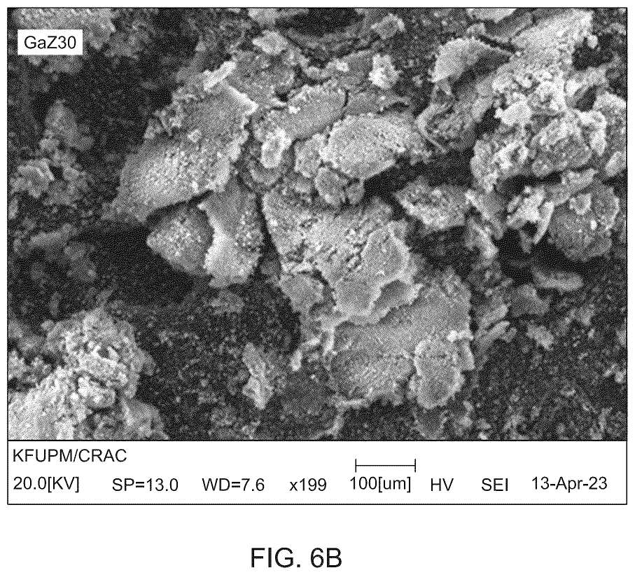

FIG. 6A and FIG. 6B depict SEM-EDS analysis of GaZ30 and Z30, illustrating the morphology of the synthesized GaZ30 and the parent Z30 through SEM analysis. EDS was also conducted to identify the elemental composition of both catalysts, and the outcomes are presented in Table 2. The morphology of Z30 and GaZ30 appears similar. Similar SEM images in FIG. 6A and FIG. 6B indicate that the Ga impregnation on the parent Z30 did not affect the crystallinity of Z30, aligning with the XRD results. The SEM images, captured at a magnification of 100 μm, revealed mesopore size ranges from 2 to 50 nm. The results of the EDS analysis showed no metal presence in Z30; however, the estimated weight percent of Si and Al was 34.83% and 4.45%, respectively. In GaZ30, the weight percent of Ga metal was estimated to be 3.92%.

TABLE 2
EDS analysis of Z30 and GaZ30

| Element | Z30 | GaZ30 |
|---|---|---|
| O | 60.6 | 59.86 |
| Si | 34.83 | 33.82 |
| Al | 4.45 | 2.34 |
| Ga | N/A | 3.92 |

### Example 8: Effect of Different Catalyst on Product Yields

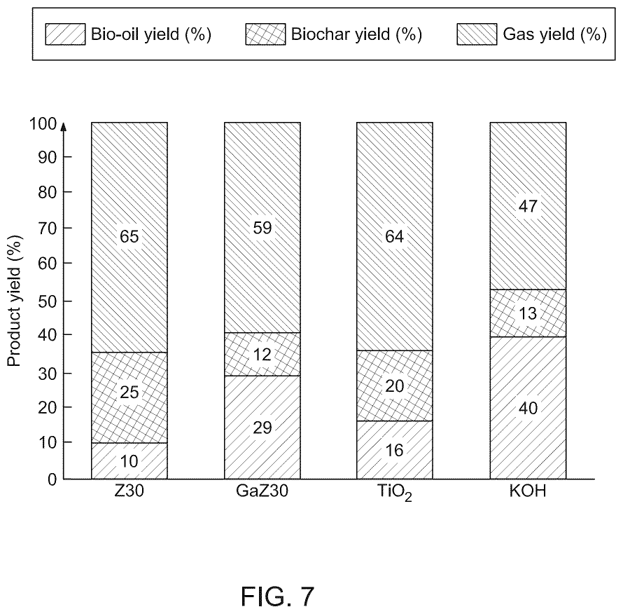

Pyrolysis is a thermochemical conversion process that takes place in a non-oxidative environment to generate liquid, solid, and gas products. FIG. 7 illustrates the effects of various catalysts, including Z30, GaZ30, TiO₂, and KOH, on the product yields obtained from the pyrolysis of SCG. The results demonstrate that the choice of catalyst influences product yields. Oil obtained from the Z30-catalyzed process was estimated to be approximately 10%, while the amount of oil obtained using GaZ30 was higher at around 29%. The highest solid (biochar) yield of 25% was obtained using Z30, while a lower solid yield (approximately 12%) was obtained using GaZ30. The gases generated using the Z30 catalyst were the highest compared to the other catalysts, with a yield of approximately 65%. The yield of gas products obtained using GaZ30 was estimated to be around 59%. The high temperature of the pyrolysis process results in the formation of volatile gases, such as CO, CO₂, and CH₄. The acidic nature of the zeolite-based catalyst and the high temperature facilitated the decomposition of large volatile molecules into smaller ones, resulting in the production of more gaseous products. Moreover, MAP generates more gas products compared to conventional pyrolysis due to its unique heating mechanism, involving selective heating, enhanced heat and mass transfer, reduced heat loss, shorter reaction times, and improved reaction kinetics. In the pyrolysis process, product distribution depends on the reaction pathway in the catalysis process. From FIG. 7, it can be observed that, in comparison to other catalysts, Z30 generated the most char yield, possibly due to the formation of coke from aromatic compounds via the polymerization and aromatization of organic compounds in the pyrolytic vapors at high temperatures.

Commercially available catalysts KOH and TiO₂ were used for comparison to Z30 and GaZ30. The highest oil yield of 40% was obtained with KOH, as its basic nature promotes the decomposition of complex organic compounds in SCG, increasing oil and gas yields. Gas and solid yields of approximately 47% and 13%, respectively, were obtained using KOH as a catalyst. The low solid yield may be attributed to KOH having the potential to reduce the formation of tars and other undesirable side products during the pyrolysis process, contributing to a cleaner and more efficient conversion. There were two layers observed in the liquid outlet, increasing its yield but compromising its quality. The bio-oil obtained from the utilization of the KOH catalyst consisted of two layers. The light fraction is referred to as KOH_LF, and the heavy fraction is referred to as KOH_HF. These two layers of the oil were characterized separately. The effect of TiO₂ was investigated on the pyrolysis of SCG, and it was observed that an oil yield of approximately 16% was achieved with TiO₂, while the yields of solid (biochar) and gas products were estimated to be 20% and 64%, respectively.

### Example 9: Characterization of Bio-Oil Samples by Simulated Distillation (SimDist) Analysis

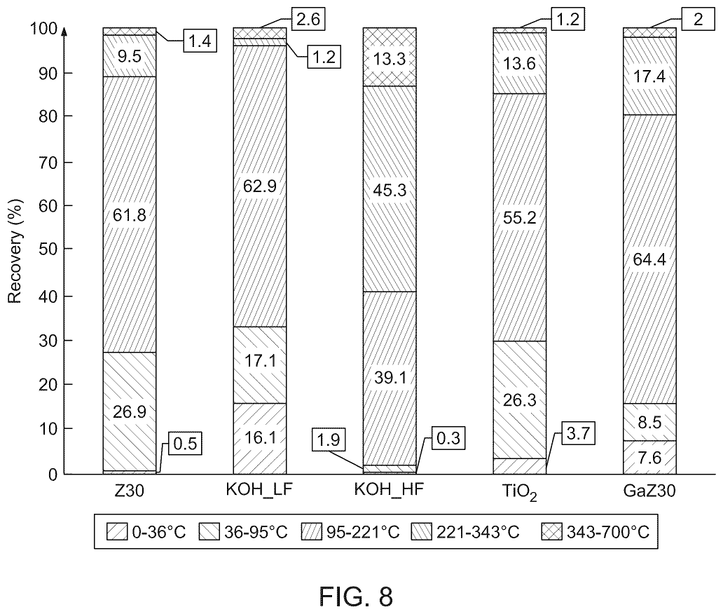

SimDist analysis was performed on bio-oil derived from SCG to reveal its boiling point distribution, as shown in FIG. 8. SimDist analysis is a tool for characterizing bio-oil and its fractions, providing insights into the boiling point distribution and composition of the sample. The analysis encompassed five oil samples obtained using four catalysts: Z30, KOH, TiO₂, and GaZ30. The highest recovery of the heavy fuel oil fraction (13.3%) occurred within the 343-700° C. boiling point range in the KOH_HF sample (KOH as the catalyst). The recovery of heavy oil fractions from the remaining samples (Z30, KOH_LF, TiO₂, and GaZ30) ranged from 1.2% to 2.6%. Diesel fraction recoveries within the temperature range of 221-343° C. varied across samples. The maximum recovery (45.3%) was observed in the KOH_HF sample, followed by GaZ30 (17.4%), TiO₂ (13.6%), and Z30 (9.5%). The KOH_LF sample exhibited the lowest diesel fraction recovery at 1.2%. SimDist analysis also encompassed the investigation of gasoline fractions (36-221° C.), revealing variations. The highest recovery (˜88%) occurred in the Z30 sample, while TiO₂, KOH_LF, and GaZ30 exhibited recoveries of 81.5%, 80%, and 72.9%, respectively. The KOH_HF sample demonstrated the lowest gasoline fraction recovery at 41%. The elevated weight percentage of KOH_HF implies a presence of heavy hydrocarbons in the bio-oil, showcasing potential as a feedstock for transportation fuel production. Conversely, the narrow boiling point range of TiO₂ and GaZ30 fractions suggests predominantly light hydrocarbons, suitable for chemical production. The large weight percentage of KOH_LF indicates the presence of oxygenated compounds in the bio-oil, potentially affecting the quality of transportation fuels derived from heavy hydrocarbons. Consequently, additional processing, such as hydrotreating or catalytic upgrading, may be used to mitigate the impact of these oxygenated compounds.

### Example 10: ¹H-NMR Analysis of Samples

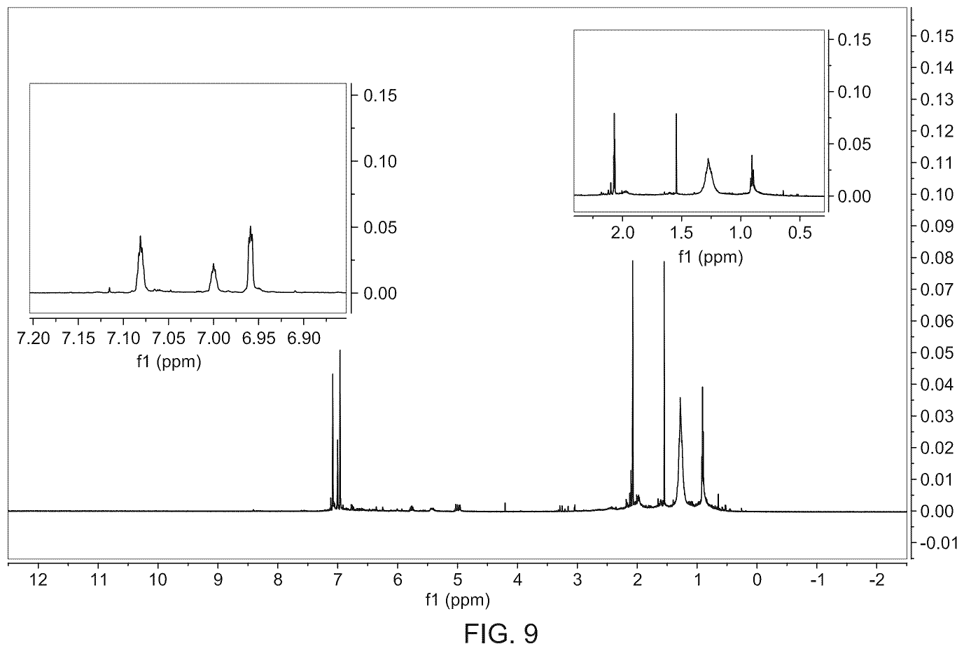

FIG. 9 depicts 1H-NMR spectra for KOH catalytic pyrolysis-derived oil. 1H-NMR spectra provide information about the chemical composition of a sample in terms of the types of hydrogen present, with the x-axis representing chemical shift and the y-axis representing signal intensity. Chemical shift refers to the resonant frequency of a nucleus in a magnetic field, typically within the range of 0-12 ppm for 1H-NMR spectra. In complex mixtures such as pyrolysis oil and gasoline, there may be overlap in the peaks, so a specified range is used to determine the occurrence of functional groups. Table 3 includes 1H-NMR chemical shifts to identify functional groups, spectral lines to support the presence of aromatic H, paraffinic CH₃ groups in the alpha position to the aromatic ring, and naphthenic CH groups in the bio-oil. Peak intensity between the range of 0 to 2 signifies the presence of paraffinic components in the bio-oil. The peaks in the region between 6.2-7.4 ppm indicates a high percentage of aromatic chemical classes in the obtained bio-oil. The presence of these aromatics was also supported by GC-MS.

TABLE 3
Characteristics ¹H-NMR chemical shift
to identify the functional groups

| Functional | | Chemical shift |
|---|---|---|
| group | H atom | region (ppm) |
| Paraffins | Paraffinic CH₃ | 0.5-1.09 |
| | Paraffinic CH₂ | 1.09-1.5 |
| | Paraffinic CH/naphthenic CH | 1.5-2 |
| Olefins | Olefinic CH₂ | 4.3-5.1 |
| | Olefinic CH | 5.1-6.2 |
| Aromatics | Paraffinic CH₃ group in alpha position to | 2-2.4 |
| | aromatic ring | |
| | Paraffinic CH₂ group in alpha position to | 2.4-4.3 |
| | aromatic ring | |
| | Aromatic H | 6.2-7.4 |

### Example 11: Elemental Analysis and HHV of Bio-Oil

Elemental analysis and higher heating value (HHV) estimations of the produced pyrolytic bio-oil were performed to evaluate its suitability for fuel production. Table 4 displays the elemental analysis and HHV of the bio-oil samples, comparing them with results from other studies on conventional SCG pyrolysis. Carbon contents of all the bio-oil samples were within the range of approximately 65-70%. Meanwhile, the hydrogen content of produced pyrolytic oil samples was within the range of approximately 7-10%. The oxygen content of bio-oil samples was estimated to be within the range of approximately 16-24%.

This analysis revealed that the carbon and hydrogen content of the produced pyrolytic oil were greater than that of the raw SCG (C: 52.58% and H: 6.36%) in all cases; however, the oxygen content of produced bio-oil samples was estimated to be lower than the raw SCG (O: 37.79%), resulting in a higher value of the bio-oil's HHV (approximately 28-33.5 MJ/kg). The removal of oxygen occurred due to decarbonylation and decarboxylation reactions, subsequently increasing the HHV of the produced oil. A small amount of nitrogen was also found in the oil, attributed to the presence of nitrogen-containing organic compounds such as caffeine.

The HHV of produced pyrolytic oil samples (approximately 28-33.5 MJ/kg) was higher than the HHV of raw SCG (22.97 MJ/kg). This increase in HHV is due to the increase in carbon density of the bio-oil. Although this HHV is lower than conventional fossil fuels, such as gasoline (44-46 MJ/kg) and diesel (44 MJ/kg), it is still comparable with other renewable fuels such as ethanol (28.9 MJ/kg). Bio-oil obtained from GaZ30 and parent Z30 exhibit good properties for potential fuel production applications.

TABLE 4
Elemental analysis of produced oil samples.

| Bio-oil | Pyrolysis | | | | | | | | HHV |
|---|---|---|---|---|---|---|---|---|---|
| Sample | reactor type | Temp | Catalyst | C | H | O | N | S | (MJ/kg) |
| GaZ30 | Catalytic | 500° C. | GaZ30 | 70.43 | 10.32 | 16.64 | 2.55 | 0.06 | 33.5 |
| Z30 | microwave | | Z30 | 70.24 | 9.78 | 16.85 | 3.06 | 0.07 | 32.89 |
| TiO₂ | pyrolysis | | TiO₂ | 68.43 | 10.41 | 18.49 | 2.6 | 0.07 | 32.93 |
| KOH_LF | (Microwave | | KOH | 65.54 | 7.17 | 24.29 | 3 | 0 | 28.71 |
| KOH_HF | heating) | | | 68.09 | 9.15 | 19.98 | 2.78 | 0 | 31.54 |
| 1 | Hydrothermal | 300° C. | Water | 71.2 | 7.1 | 18.7 | 3 | NA | 31 |
| | liquefaction | | solvent | | | | | | |
| | (Conventional | | | | | | | | |
| | heating) | | | | | | | | |
| 2 | Tube furnace | 450° C. | — | 74 | 9.8 | 13.4 | 2.6 | 0.17 | 23.3 |
| | reactor | | | | | | | | |
| | (Conventional | | | | | | | | |
| | slow heating) | | | | | | | | |
| 3 | Fluidized bed | 550° C. | — | 54.27 | 7.41 | 35.26 | 3.06 | NA | 20.38 |
| | reactor | | | | | | | | |
| | (Conventional | | | | | | | | |
| | Fast heating) | | | | | | | | |
| 4 | Screw- | 500° C. | — | 44.97 | 12.03 | 42.07 | 0.8 | 0.12 | NA |
| | conveyor | | | | | | | | |
| | reactor | | | | | | | | |
| | (Conventional | | | | | | | | |
| | heating) | | | | | | | | |
| 5 | Liquefaction | 500° C. | NaOH | 66.6 | 9.2 | 21.9 | 2.3 | NA | 31.9 |
| | Autoclave | | | | | | | | |
| | reactor | | | | | | | | |
| | (Conventional | | | | | | | | |
| | heating) | | | | | | | | |
| 6 | Catalytic | 460° C. | Hematite | 74.33 | 10.49 | 13.81 | 1.35 | 0.02 | 38.99 |
| | Bubbling | | Magnetite | 71.9 | 10.35 | 15.94 | 1.78 | 0.02 | 36.96 |
| | fluidized-bed | | | | | | | | |
| | reactor | | | | | | | | |
| | (Conventional | | | | | | | | |
| | heating) | | | | | | | | |

[1] Yang, L. et al., Hydrothermal liquefaction of spent coffee grounds in water medium for bio-oil production, Biomass Bioenergy, 2016, 86, 191-198; [2] Vardon, D. R. et al., Complete Utilization of Spent Coffee Grounds To Produce Biodiesel, Bio-Oil, and Biochar, ACS Sustain Chem Eng, 2013, 1, 1286-1294; [3] Bok, J. P. et al., Fast pyrolysis of coffee grounds: Characteristics of product yields and biocrude oil quality, Energy, 2012, 47, 17-4; [4] Kelkar, S. et al., Pyrolysis of spent coffee grounds using a screw-conveyor reactor, Fuel Processing Technology, 2015, 137, 170-178; [5] Yang, 1. et al., Co-liquefaction of spent coffee grounds and lignocellulosic feedstocks, Bioresour Technol, 2017, 237, 108-121; and [6] Vu Ly, H. et al., Catalytic pyrolysis of spent coffee waste for upgrading sustainable bio-oil in a bubbling fluidized-bedreactor: Experimental and techno-economic analysis, Chemical Engineering Journal, 2022, 427, which are incorporated herein by reference in their entirety.

### Example 12: FTIR Analysis

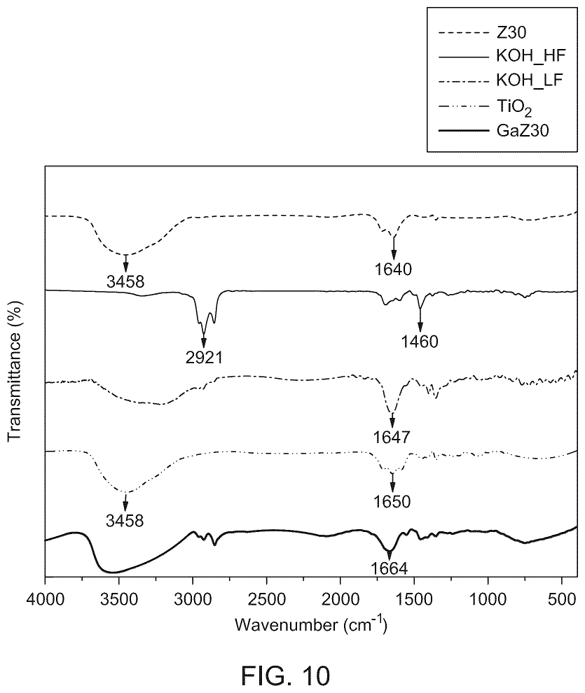

FIG. 10 shows the wavenumber and transmittance of the absorption bands via FTIR spectroscopy for the bio-oils produced from pyrolysis with the catalysts of the current disclosure. FIG. 10 may be used to determine the relative abundance of the different functional groups present in the samples. Functional groups present in the pyrolysis oil were identified through Fourier-transform infrared (FTIR) analysis conducted with a Nicolet 6700 model instrument supplied by Naizak Global Engineering Systems. A KBr pellet was utilized to mount a drop of the oil, and the IR spectra were recorded in the range of 4000 cm⁻¹ to 400 cm⁻¹. The bio-oils obtained from the pyrolysis process were subjected to FTIR spectroscopy for characterization purposes.

The Z30 catalyst displayed a strong absorption band at 3600-3050 cm⁻¹, indicative of hydroxyl groups (OH) associated with carboxylic acids, alcohols, and phenols. Additionally, the presence of a band at 1750-1500 cm⁻¹ suggests the existence of carbonyl groups (C═O) linked to hydroxy unsaturated ketones and aldehydes. The high transmittance observed for the hydroxyl group band indicates an abundance of carboxylic acids, alcohols, and phenols in the Z30 sample. These findings suggest that Z30 may play a role in acid-base reactions and oxidation-reduction processes. In contrast, the KOH catalyst resulted in two bio-oil layers (i.e., KOH_LF and KOH_HF). KOH_HF (heavy fraction) exhibited a relatively low transmittance for both the absorption band at 3000-2800 cm⁻¹, associated with methylene groups (CH₃) of aliphatic groups, and the band at 1460 cm⁻¹, related to methylene groups (CH₂) bending vibrations. This suggests a reduced abundance of aliphatic groups in the KOH_HF sample. The KOH_LF (light fraction) sample displayed an absorption band at 3600-3050 cm⁻¹, indicating the presence of hydroxyl groups (OH) of carboxylic acids, alcohols, and phenols; however, the low transmittance for the hydroxyl group band and the high transmittance for the carbonyl group band at 1750-1500 cm-1 suggest a composition comprising of a low abundance of carboxylic acids, alcohols, and phenols, and a higher presence of hydroxy unsaturated ketones and aldehydes. These results imply that KOH may exhibit different reactivity patterns compared to other catalysts, possibly favoring specific types of chemical transformations.

FTIR analysis of the TiO₂ catalyst revealed high transmittance for both the hydroxyl group band (3600-3050 cm⁻¹) and the carbonyl group band (1750-1500 cm⁻¹). This indicates an abundance of carboxylic acids, alcohols, phenols, hydroxy unsaturated ketones, and aldehydes in the TiO₂ sample. The presence of these functional groups suggests that TiO₂ may be versatile in catalyzing a range of chemical reactions. The GaZ30 catalyst exhibited absorption bands similar to Z30, with high transmittance for both the hydroxyl group band (3600-3050 cm⁻¹) and the carbonyl group band (1750-1500 cm⁻¹). This implies a comparable composition, characterized by an abundance of carboxylic acids, alcohols, phenols, hydroxy unsaturated ketones, and aldehydes. These results indicate similarities in reactivity between GaZ30 and Z30 catalysts, as both possess similar functional group compositions.

### Example 13: Gas Chromatography-Mass Spectrometry (ZSM-5) Analysis

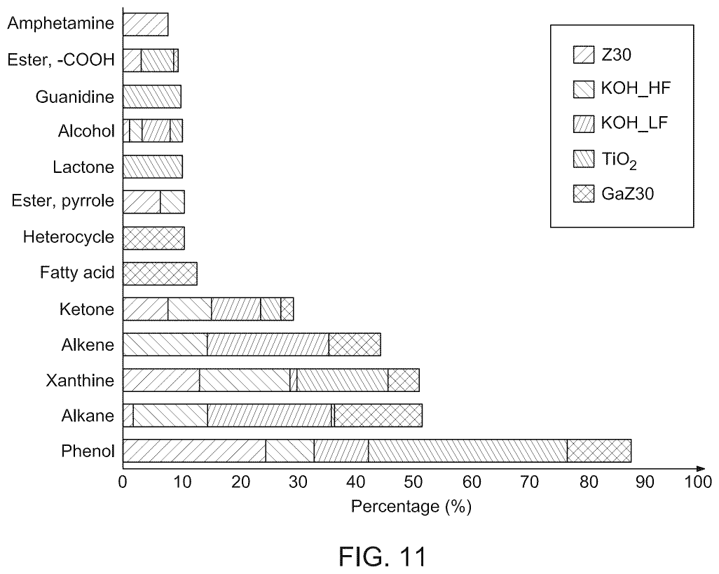

GC-MS analysis revealed the presence of various organic molecules in the bio-oil samples, including alkanes, alcohols, ketones, aromatics, and heterocycles. The formation of phenol was observed via GC-MS analysis and other compounds were ionized and detected by the mass spectrometer and presented in FIG. 11. GC-MS analysis, a robust technique for detecting and identifying organic molecules in complex mixtures, was used to characterize the bio-oil samples from pyrolysis processes. Understanding the chemical composition of bio-oil is used for determining its potential applications and properties. GC-MS analysis was performed using an instrument equipped with a capillary column. The samples were introduced into the column, which was gradually heated. As the temperature increased, the compounds present in the bio-oil samples vaporized and separated based on their boiling points and chemical properties.

The formation of phenol can be attributed to the thermal degradation of lignin present in spent coffee grounds (SCG). Lignin depolymerizes and undergoes fragmentation reactions, resulting in the production of phenolic subunits. The phenol content varies across catalysts, with TiO₂ exhibiting 34% production of phenol. This suggests that TiO₂ plays a role in promoting the decomposition of lignin and facilitating the formation of phenolic intermediates. The catalytic activity of TiO₂, attributed to its high surface area and redox properties, enables the cleavage of lignin bonds and subsequent phenol generation.

The presence of alkane compounds in the GC-MS analysis indicates the thermal decarboxylation and decarbonylation of carboxylic acids and ketones, respectively, present in the bio-oil. Carboxylic acids, derived from the breakdown of acetic acid and other organic acids in coffee grounds, undergo decarboxylation to produce alkane compounds. Ketones, originating from the thermal cracking and rearrangement of oxygenated compounds, experience decarbonylation to yield alkanes. Catalysts influence these reactions differently, resulting in varying weights of alkanes. GaZ30 exhibits the second-highest weight of alkanes (15.02%), indicating its promotion of decarboxylation and decarbonylation reactions during the pyrolysis process. Xanthine, a heterocyclic compound, is formed through the thermal degradation of purine-based compounds found in spent coffee grounds (SCG), such as caffeine and theobromine. Purine compounds undergo deamination, dehydroxylation, and ring-opening reactions, leading to the formation of xanthine intermediates. The effects of catalysts on xanthine formation vary, with KOH_LF (light fraction) showing the highest weight (15.66%). The high basicity and surface area of KOH_LF may facilitate the degradation and stabilization of purine compounds, resulting in increased xanthine production during pyrolysis.

The presence of alkenes indicates the deoxygenation of oxygenated compounds, including aldehydes, ketones, and acids, present in the bio-oil. These oxygen removal reactions involve thermal cracking, decarboxylation, and decarbonylation processes. The KOH catalysts, both lower and upper, exhibit higher weights of alkenes compared to other catalysts. KOH_LF has a weight of 21% alkene, while KOH_HF (heavy fraction) has a weight of 14.4%. This indicates the strong catalytic promotion of oxygen removal reactions, leading to increased alkene formation. The high basicity and surface properties of the KOH catalysts enhance the elimination of oxygen-containing functional groups, favoring the generation of alkenes. Ketones are formed through the thermal cracking and rearrangement of oxygenated compounds present in the bio-oil. During pyrolysis, functional groups such as hydroxyl and carbonyl groups undergo elimination reactions, resulting in ketone formation. The weight of ketones varies across catalysts, with KOH_HF exhibiting the highest value (8.46%). The catalytic activity of KOH_HF promotes the deoxygenation of oxygenated compounds, favoring the formation of ketones through the removal of hydroxyl and carbonyl groups.

Fatty acids are detected in GaZ30-catalyzed samples, indicating their incomplete conversion during pyrolysis. Lipids and triglycerides present in coffee grounds can undergo thermal decomposition, resulting in the formation of fatty acid intermediates. The weight of fatty acids in GaZ30 was 12.55%. GaZ30 likely enhances the breakdown of lipids, favoring the accumulation of fatty acids in the bio-oil. Catalytic properties of GaZ30, such as its surface acidity and redox behavior, may facilitate the conversion of lipids into fatty acids. The presence of heterocycles was also detected in GaZ30-catalyzed samples. Heterocycles can be derived from the degradation and rearrangement of nitrogen-containing compounds present in coffee grounds. GaZ30 exhibits a weight of 10.4% for heterocycles, indicating its role in promoting the formation or stabilization of heterocyclic intermediates. The surface properties and catalytic characteristics of GaZ30 facilitate the generation of heterocycles through specific reaction pathways.

Ester and pyrrole compounds are identified in Z30 and KOH_LF catalyzed samples. Ester compounds result from the esterification of carboxylic acids present in the bio-oil, while pyrrole compounds can arise from the degradation of nitrogen-containing compounds, such as amino acids or proteins, in coffee grounds. Z30 exhibits a weight of 6.31% for ester compounds, while KOH_LF has a combined weight of 4.00% for ester and pyrrole compounds. The catalytic activities of Z30 and KOH_LF promote esterification and pyrrole formation reactions, contributing to the observed weights of these functional groups.

Lactone compounds are detected in TiO₂-catalyzed samples. Lactones form through the intramolecular esterification of hydroxyl-containing compounds, such as alcohols or phenols, present in the bio-oil. TiO₂ exhibits a weight of 10.01% for lactones. The high surface area and catalytic activity of TiO₂ facilitate esterification reactions, promoting lactone formation. The absence of lactones in other catalysts suggests lower catalytic efficiency in promoting lactone formation.

The presence of alcohols indicates dehydration and deoxygenation of oxygenated compounds in the bio-oil. Hydroxyl groups are removed through thermal cracking and elimination reactions. Alcohol weights vary among catalysts, with KOH_HF showing the highest weight (4.83%), followed by KOH_LF (2.11%). These catalysts promote the removal of hydroxyl groups, enhancing deoxygenation reactions, and favoring alcohol formation. Guanidine compounds, derived from the degradation of caffeine and related nitrogen-containing compounds, are observed in TiO₂-catalyzed samples. TiO₂ exhibits a weight of 9.75% for guanidine. The specific interactions between caffeine-derived intermediates and the TiO₂ surface may facilitate the formation or stabilization of guanidine compounds through various reaction pathways. Surface properties and redox behavior of TiO₂ may play a role in promoting guanidine formation.

Ester and carboxylic acid compounds are identified in Z30 and TiO₂ catalysts. Ester compounds result from the esterification of carboxylic acids present in the bio-oil, while carboxylic acids can also form through the breakdown of organic acids and other oxygenated compounds during pyrolysis. Z30 exhibits a weight of 2.99% for ester compounds, while TiO₂ has a weight of 5.65% for ester and carboxylic acid compounds. The catalytic activities of zeolite (Z30) and TiO₂ can promote esterification reactions, contributing to the observed weights of ester compounds. The breakdown of organic acids and oxygenated compounds during pyrolysis contributes to the presence of carboxylic acids.

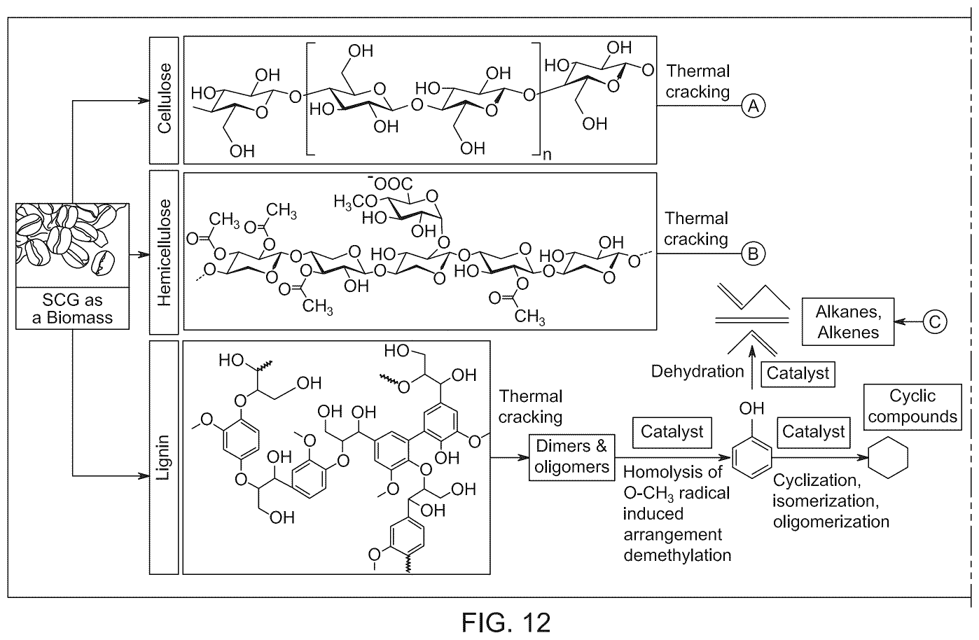

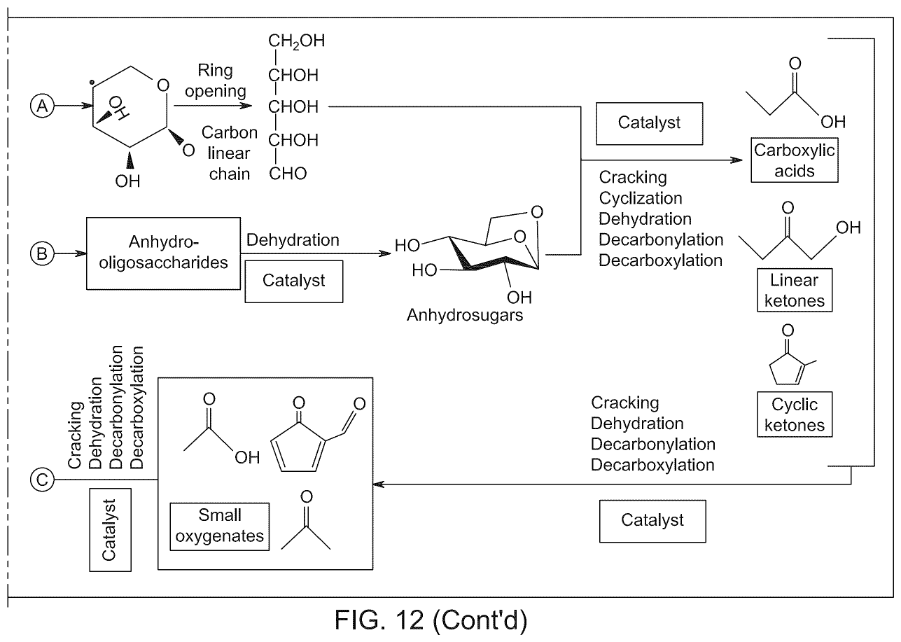

Amphetamine, derived from the degradation of caffeine and related nitrogen-containing compounds, is observed exclusively in Z30-catalyzed samples. Z30 exhibits a weight of 7.70% for amphetamine. The interactions between caffeine-derived compounds and the Z30 catalyst may promote the formation or stabilization of amphetamine intermediates through specific reaction pathways. Z30's catalytic properties, such as its surface acidity and redox behavior, may play a role in facilitating amphetamine formation. FIG. 12 depicts possible reaction pathways and mechanisms for the degradation of SCG to bio-oil.

SCG was converted to bio-oil using a catalytic MAP approach. The utilization of various catalysts such as Z30, GaZ30, KOH, and TiO₂ during MAP showed an impact on product yields and quality. The results underscore the importance of catalyst selection and various properties in influencing the distribution of pyrolytic product yields. Z30 exhibited the highest char yield at 25%, while GaZ30 favored the formation of liquid content (29%). The highest liquid yield of 40% was obtained from the process utilizing KOH as a catalyst. SimDist analysis of SCG-derived bio-oil samples showed that the utilization of the Z30 catalyst in the pyrolysis process led to recovery of gasoline (88.7%) and diesel fractions (9.5%), indicating its potential for transportation fuel production. 1H-NMR spectra demonstrated the existence of aromatic (alkenes) and paraffinic components. GC-MS analysis showed diverse organic molecules, with TiO₂ promoting phenol formation and KOH enhancing alkene production. The catalytic influence on the formation of heterocycles, esters, lactones, alcohols, and specific compounds like guanidine and amphetamine underscores the complexity of the pyrolysis process. These findings show the catalyst-dependent nature of bio-oil compositions and offer insights into potential applications and further processing for fuel production.

Numerous modifications and variations of the present disclosure are possible in light of the above teachings. Therefore, it is to be understood that within the scope of the appended claims, the disclosure may be practiced other than as specifically described herein.

1. A method of producing a biofuel, comprising:
mixing coffee grounds, silicon carbide granules, and a catalyst to form a mixture,
wherein a ratio of the mass of the coffee grounds to the mass of the catalyst is 10:1 to 20:1,
microwave irradiating the mixture to form a product,
wherein the product comprises a first vapor, a second vapor, and a char; and
condensing the first vapor to form the biofuel.

2. The method of claim 1, wherein the catalyst comprises a calcined ZSM-5 and a gallium dopant.

3. The method of claim 2, wherein the catalyst comprises the gallium dopant in an amount of 2 to 6 wt. % based on a total weight of the catalyst.

4. The method of claim 1, further comprising microwave irradiating at a first power output of 800 to 1000 W per 15 grams of coffee grounds for 1 to 10 minutes.

5. The method of claim 1, further comprising microwave irradiating at a second power output of 50 to 200 W per 15 grams of coffee grounds for 10 to 30 minutes.

6. The method of claim 1, wherein an amount of biofuel produced is from 5 to 45 wt. percent based on an initial weight of the coffee grounds.

7. The method of claim 1, wherein the biofuel comprises amphetamines, esters, guanidines, alcohols, lactones, pyrroles, heterocycles, fatty acids, ketones, alkenes, xanthine, alkanes, and phenols.

8. The method of claim 2, wherein the catalyst is made by a process comprising:
dissolving a zeolite Socony mobil-5 (ZSM-5) in water to form a first solution;
dissolving a gallium salt in water to form a second solution;
mixing the first solution and the second solution to form a third solution;
evaporating the water from the third solution at a temperature of 40 to 60° C.;
drying the third solution at a temperature of 70 to 90° C. to form a product; and
calcinating the product at a temperature of 500 to 600° C. to form the catalyst.

9. The method of claim 8, wherein the ZSM-5 has a SiO₂: Al₂O₃ ratio of 20:1 to 40:1.

10. The method of claim 1, wherein the mixing occurs in an inert environment.

11. The method of claim 10, wherein an inert gas in the inert environment flows at a rate of 60 to 100 mL/min.

12. The method of claim 1, wherein the mixing occurs in a quartz pyrolysis reactor.

13. The method of claim 12, wherein the quartz pyrolysis reactor is connected in sequence to a heating line, a condensing line, and a collector.

14. The method of claim 1, further comprising drying the coffee grounds at a temperature of 100 to 140° C. for 20 to 28 hours before the mixing.

15. The method of claim 1, wherein a weight ratio of the coffee grounds to the catalyst is 10:1 to 20:1.

16. The method of claim 1, wherein a weight ratio of the silicon carbide granules to the coffee grounds is 20:1 to 40:1.

17. The method of claim 1, wherein the coffee grounds are spent coffee ground.

18. The method of claim 1, wherein a pyrolysis temperature is 400 to 600° C.

19. The method of claim 1, further comprising:
separating the silicon carbide granules from the char and the catalyst;
washing the silicon carbide granules with a non-polar organic solvent; and
drying the silicon carbide granules.

20. The method of claim 1, wherein the biofuel comprises 15 to 20% diesel and 70 to 75% gasoline based on a total weight of the biofuel.
